(19) United States
(12) Patent Application Publication
(10) Pub. No.: US 2012/0002691 A1
(43) Pub. Date: Jan. 5, 2012

(54) SYSTEM AND METHOD FOR PROVIDING A SAFETY MECHANISM FOR A LASER-EMITTING DEVICE

(76) Inventor: XIAO WEI TAO, Shanghai (CN)

(21) Appl. No.: 12/943,043

(22) Filed: Nov. 10, 2010

Related U.S. Application Data
(60) Provisional application No. 61/360,477, filed on Jun. 30, 2010.

(51) Int. Cl. H01S 3/00

(52) U.S. Cl. 372/38.07

(57) ABSTRACT

This invention generally relates to systems and methods for providing a safety mechanism for a laser-emitting device, and more specifically, to providing a safety mechanism for a portable laser-emitting illumination device. A lock interface is provided that allows that user to input a unlock code to activate or deactivate the device.

### CROSS-REFERENCE TO RELATED APPLICATION

This application claims the benefit of U.S. Provisional Application No. 61/360,477, filed on Jun. 30, 2010, the contents of which are hereby incorporated by reference in their entirety.

### BACKGROUND

1. Field of Invention

This invention generally relates to systems and methods for providing a safety mechanism for a laser-emitting device, and more specifically, to providing a safety mechanism for a portable laser-emitting illumination device.

2. Description of Related Art

Many types of laser-based devices and systems, having a wide range of applications, such as in medical technology, communications, manufacturing, and computing, are becoming increasingly well known and commercially available. The lasers used in many of these devices and systems are often capable of producing powerful outputs that are potentially harmful to both people and equipment. As a result, many types of safety devices for use in conjunction with laser-based equipment, and standards designed to ensure that laser-based equipment may be safely operated, have been developed and continue to evolve.

The potential dangers associated with lasers are several. For example, burns to the skin and clothing or even to nearby equipment, walls or other objects may be sustained if there is exposure to laser radiation of sufficient energy for a sufficient duration. Further, some forms of laser radiation can damage an unprotected human eye even before the eye has time to react to the exposure. This may lead to considerable physical damage to the eye, such as cutting or burning, and can also result in temporary or permanent vision impairment or blindness. Depending on the energy, wavelength and focus of the laser radiation, these dangers may be minimal unless the object comes within a few inches of the laser source. At other focal lengths however, the laser radiation may be harmful even at long distances from the source.

Because of the potential dangers associated with lasers, a variety of safety devices have been devised to promote safe operation of laser-based equipment. Common forms of safety equipment include items such as safety goggles, workstation enclosures and warning labels, as well as more complex mechanical interlocks and shutter systems designed to disable the laser when safety sensors are triggered. Other systems have been designed to detect and disable rogue laser beams that are reflected, scattered, aimed or otherwise impinge on walls of a room or enclosure containing the laser equipment. One such system includes infrared monitoring of the walls and ceiling to detect heating of the surfaces by stray laser energy.

Some inroads have also been made in applying laser technology to portable illumination devices in limited areas. One major drawback of such uses of lasers has been that the laser beam emitted by such low-power devices has the potential to produce irreversible eye damage if a person gazes directly into the light source. Thus, these devices are not “eye safe.” Naturally, this problem becomes exacerbated as attempts are made to increase the output power of such devices.

To alleviate the risk of inadvertent or accidental exposure, there exists a need for a system and method for providing a safety mechanism for laser-emitting devices that is practical, cost-effective, and easy to use.

### SUMMARY

In an embodiment, this invention is directed to a portable laser-emitting device, comprising: a housing; at least one laser diode placed within the housing; a power supply coupled to the housing; a microcontroller placed within the housing, the microcontroller storing an unlock code; a first input means coupled to the housing, the first input means configured to enable the microcontroller to receive an input signal; and a second input means coupled to the housing, the second input means configured to transmit the input signal to the microcontroller, wherein the microcontroller is configured to initially activate the laser diode when the input signal is equal to the unlock code.

In another embodiment, this invention is directed to a method of activating a laser-emitting device, comprising the steps of: receiving an input signal at an input means; transmitting the input signal from the input means to a microcontroller; comparing the input signal to an unlock code at the microcontroller; and enabling the laser-emitting device for use when the input signal equals the unlock code.

In yet another embodiment, this invention relates to a portable light-emitting device, comprising: a housing; a laser diode placed within the housing; a microcontroller coupled to the laser diode; and an input means coupled to the microcontroller, the input means configured to transmit an input signal to the microcontroller, wherein the microcontroller is configured to activate or deactivate the light-emitting device based on the input signal.

### BRIEF DESCRIPTION OF THE DRAWINGS

These and other embodiments of this invention will be discussed with reference to the following exemplary and non-limiting illustrations, in which like elements are numbered similarly, and wherein:

FIG. 1 is a cross-sectional side view of an embodiment of a portable laser-emitting device;

FIG. 2 is a flowchart of activation and deactivation of the portable laser-emitting device;

FIG. 3 is a view of a lock interface having a numeric keypad;

FIG. 4 is a view of a lock interface having a touch-sensitive surface;

FIG. 5 is a view of a lock interface having an alpha-numeric keypad; and

FIG. 6 is a view of a lock interface having a single push-button.

### DETAILED DESCRIPTION OF EMBODIMENTS

Before the present method and hardware enablement are described, it is to be understood that this invention in not limited to the particular methodologies, and hardware described, as these may vary. It is also to be understood that the terminology used in the description is for the purpose of describing the particular versions or embodiments only, and is not intended to limit the scope of the present invention which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. The disclosed embodiments are merely exemplary of the invention, which may be embodied in various forms.

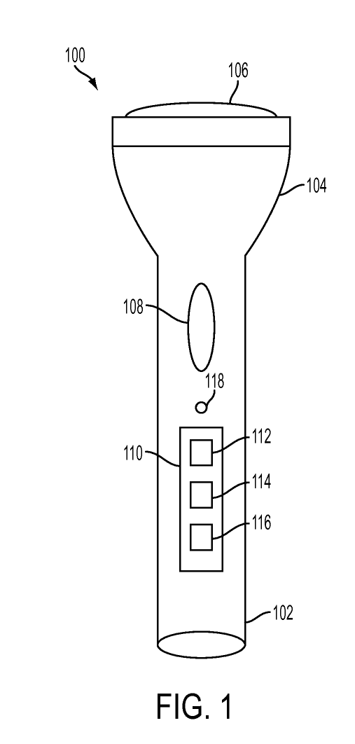

FIG. 1 is a cross-sectional side view of a first preferred embodiment of a portable laser-emitting device of the present invention. With reference to FIG. 1, in an exemplary embodiment, a portable laser-emitting device 100 (hereinafter, a “PLED”) can be in the shape of a traditional flashlight or light-pipe, with a laser-emitting head portion 104, and a housing 102 configured to be held or carried by a user. The PLED 100 can include a lens 106 attached to the head portion 104, wherein a laser diode or laser diode array, or a combination thereof, is disposed (not shown).

In an embodiment, an activation switch 108 is disposed on the housing 102. The activation switch 108 is used to toggle the laser emission. For example, upon depressing the activation switch 108, the laser diode is connected to a power supply, and a laser is emitted from the head portion 104. Conversely, depressing the activation switch 108 while the laser diode is active disconnects the power supply connection to the laser diode, and the laser emission is turned off.

The activation switch 108 can be any type of button, switch, rotary dial, touch-sensitive mechanism, screw-type switch, or slide control that can toggle the laser emission, as well as toggle various types of laser outputs. For example, the activation switch 108 can focus or broaden the laser output from a beam to a flashlight-like unfocused effect, as well as toggle various laser patterns, such as strobe and dazzle effects. The activation switch 108 can also be used to toggle different colored laser diodes from being activated, in order to produce different colored laser light outputs.

The PLED 100 also includes a lock interface 110 that prevents the unauthorized or accidental engagement or disengagement of the laser diode. In an embodiment, in order to unlock the PLED 100 for use, the lock interface 110 requires that buttons 112, 114, and 116 are depressed in a pre-defined unlock code. For example, button 112, button 116, and button 114 must be depressed in order for the power supply or circuitry within the housing 102 and head portion 104 from being engaged to energize the laser diode or diodes. In the embodiment shown in FIG. 1, three buttons are shown on the lock interface 110; however, the lock interface 110 can include a single button, or a plurality of buttons, such as an entire alpha-numeric keypad.

In an embodiment, the unlock code can be a binary ordered sequence as described above, or its can include a duration factor. For example, the sequence can be two short presses, followed by two long presses. In an embodiment, a short press is a depression lasting under half a second, and a long press is a depression lasting greater than one second. Any combination of depression durations can be used, and the invention is not limited to the durations disclosed herein. The PLED 100 remains inactive until a correct unlock code is entered by the user, thus preventing inadvertent activation or use by unintended users, such as children or elderly persons.

In this embodiment, an audible cue can be generated, such that upon depression on a button, an audible sound is provided to the user, so that the user can determine the length of the depression using audible cues.

In an embodiment, a pre-defined unlock code is determined by the manufacturer of the PLED 100, and stored on a microcontroller, memory chip, processor, or semiconductor that is coupled to the lock interface 110. The unlock code can be customizable and alterable by the user, or alternatively, the unlock code may not be modified from the factory settings.

In an embodiment, to alter the pre-defined unlock code, an administrator code, different from the unlock code, must be entered to place the lock interface 110 into a sequence-altering mode. In another embodiment, the unlock code can be modified using an external computing device, such as a computer, a mobile phone, PDA, iPhone, Blackberry, or other similar device, and the updated unlock code can be transferred to the PLED 100 via USB, SmartDisk, MicroDisk, or parallel or serial connection technologies. In yet another embodiment, the updated unlock code can be transferred to the PLED 100 from an external computing device via a short-range wireless technology, such as BlueTooth, Zigbee, or RFID.

In an embodiment, the housing 102 includes an indicator 118, such as an indicator light or display, which prompts the user that the PLED 100 is in a programming mode, an unlocked mode, or a locked mode. In another embodiment, the indicator 118 can display the number of unlock attempts are remaining For example, the lock interface 110 can be programmed to allow up to three unsuccessful attempts to enter a correct unlock code. Upon each unsuccessful attempt, the indicator 118 is decremented to show the remaining number of attempts. After a user reaches the maximum number of unsuccessful attempts, the lock interface 110 can be automatically disabled, preventing further activation attempts. In order to restore the PLED 100 and allow further unlocking attempts to be entered to the lock interface 110, either the administrator code, or another code different from the unlock code, must be entered.

In yet another embodiment, the unlock code can be entered remotely by the user. The PLED 100 can include a wireless transceiver allowing it to receive and send communication signals to a remote location. In this embodiment, the user can use an external computing device that is connected to a wireless or mobile network, such as a portable phone, smartphone, iPhone, iPad, Blackberry, laptop computer, netbook, or any other portable device that is capable of accessing a wireless network. The external computing device, such as an iPhone, can have an application with a graphical user interface that allows remote control of the PLED 100 and input of the unlock code. In another embodiment, the application can be web-based, and a user can input the unlock code through a web-based interface. The wireless transceiver can be compatible with any wireless transmission protocol, such as, for example, BlueTooth, Zigbee, or RIFD.

In an embodiment, a wireless transceiver is also coupled to, or embedded within, a pair or safety glasses or another safety device that is used during the operation of the PLED 100. Upon sensing a signal from the safety glasses, the PLED 100 is unlocked and activated for use. This embodiment serves a dual purpose of controlling the PLED 100, as well as encouraging users to wear safety glasses when operating the PLED 100. Furthermore, different safety glasses can emit various unlock signals so that one pair of glasses, such as adult glasses, allows the user to access the full output capabilities of the laser diode. Similarly, another pair of glasses, such as child glasses, allows only a low power output of the laser diode.

Furthermore, the PLED 100 can include a RF/RFID transceiver, or another short-range wireless technology transceiver, to accept a reading from an external wireless device, such as an RFID-equipped card or key-fob, to activate, deactivate, or otherwise control the PLED 100. The RFID device can include an internal memory that records details of each PLED 100 use, such as activation/deactivation times, output power levels, output types, etc. The RFID device may also record other usage characteristics, such as output direction and angle, and location of use, using built-in or external devices such as a compass, gyro meter, accelerometer, GPS, and/or tilt meter.

In yet another embodiment, multiple unlock codes can be programmed, where each code is associated with a different power, intensity, or wavelength output of the laser diode. For example, one code can be used to all up to the maximum power output of the laser diode to be emitted. Another code can be used to obtain an intermediate power output, and yet another code can be used to allow only a low power output. Thus, multiple users, each with a different unlock code, can have different levels of access to the PLED 100.

In an embodiment, each unlock code can pertain to a different safety level. The American National Standards Institute (ANSI) has developed laser safety guidelines (ANSI Z136.1-1993) that set forth the maximum permissible exposure to laser radiation to prevent permanent eye damage. In general terms, the maximum level of exposure is a function of the laser wavelength, the irradiance (also called the intensity or power density) at the location of the eye, which is typically measured as watts per square centimeter (W/cm.sup.2), and the duration of the exposure. Different unlock codes can be used for different situations, such as illumination distance, and surrounding objects, that conform to different ANSI standards for various operating environments.

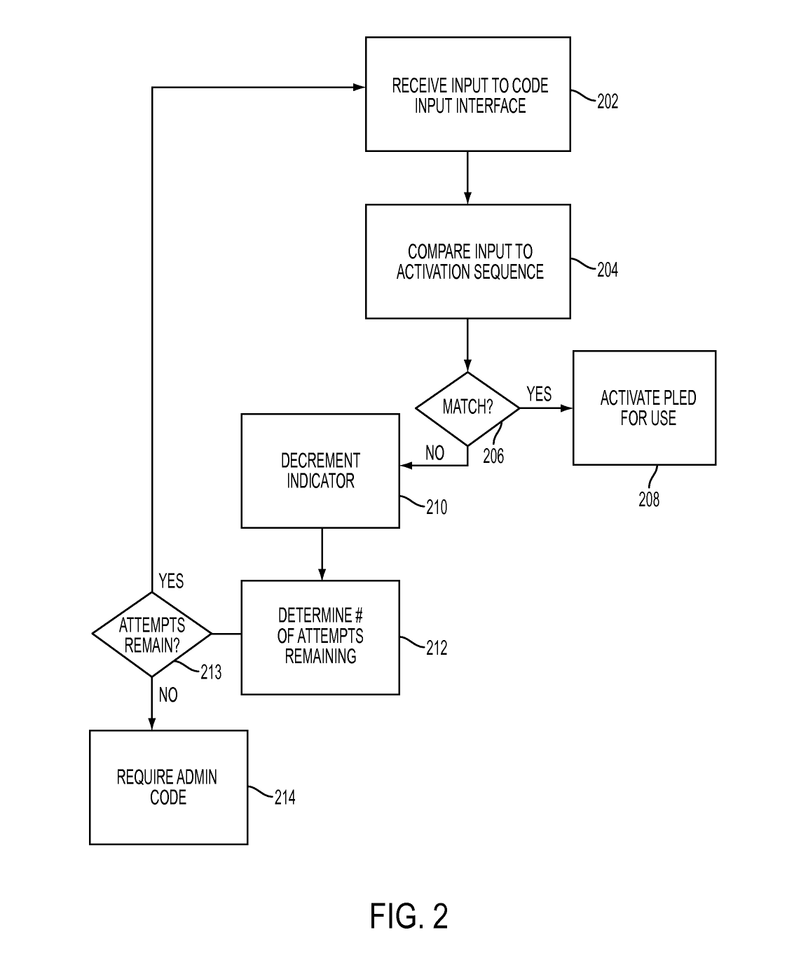

FIG. 2 is a flowchart of activation and deactivation of the portable laser-emitting device. In step 202, an input, such as from a user's hand, finger, or stylus, or from a remote signal, is received by the lock interface 110 or microcontroller. As described earlier, the lock interface 110 can take various forms, such as a button, a slide mechanism, a plurality of buttons, a keypad, switches, or a touch-sensitive interface. The mechanical input is transformed into an input signal by the microprocessor. The microcontroller then compares the input signal to the unlock code in step 204. The unlock code can be permanently stored in a memory coupled to the microprocessor. The memory can be, for example, RAM, ROM, Flash memory, or any other type of suitable memory device. In another embodiment, the microcontroller can transmit the input signal to a remote location where the unlock code is stored, such as a remote database or repository. The comparison can be done remotely, and the result can be transmitted back to the microcontroller.

In step 206, the microcontroller determines if the input signal matches the unlock code. If there is a match, then in step 208, the PLED 100 is activated for use. Alternatively, the PLED 100 is deactivated if the input signal was entered in order to turn off or lock an active PLED 100.

In another embodiment, if there is a match at step 206, then the microcontroller determines any output or operational characteristics associated with the unlock code, such as a maximum laser diode power output, or output type, and the corresponding output is modified by the microcontroller.

If there is not a match at step 206, then in step 210, the microcontroller decrements an attempt counter. The indicator 118 is adjusted to display the remaining number of attempts based on the attempt counter value. In step 212, the microcontroller then determines if the attempt counter has a value greater than zero. If the attempt counter has a value greater than zero, this indicates that the user still has input attempts remaining, and in step 213, the process returns to step 202 where an input can be entered again at the lock interface 110.

If however, the microcontroller determines that the attempt counter is equal to zero at step 212, then in step 214, an administrator code is required to unlock the PLED 100, either by resetting the unlock code, or resetting the attempt counter to a value greater than zero.

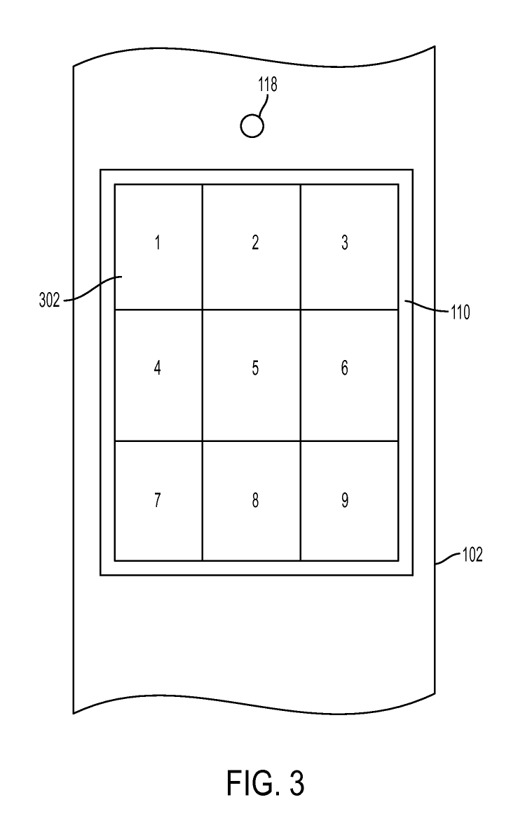

FIG. 3 is a view of a lock interface having a numeric keypad. In an embodiment, the lock interface 110 consists of a numeric keypad, similar to that found on telephones handsets. The lock interface 110 is located on the housing 102, and can include a plurality of input keys 302. In order to activate the PLED 100, a correct unlock code must be entered using the input keys 302. The unlock code can consist of a string of numbers, such as 1-2-3-4-5. The unlock code can be a short as one number, or as long as the user desires.

In an embodiment, the input keys 302 can illuminate via a backlight, or the indicator 118 can illuminate, as the input keys 302 are depressed.

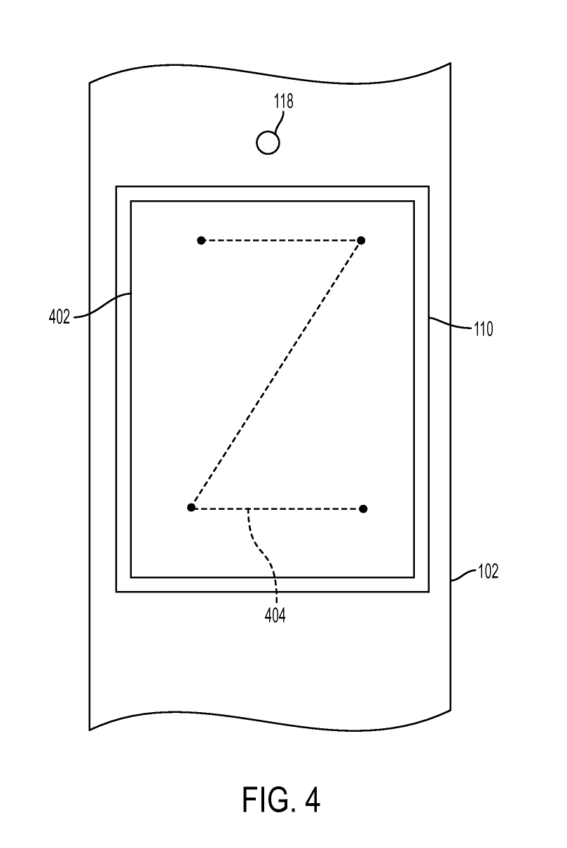

FIG. 4 is a view of a lock interface having a touch-sensitive surface. The touch-sensitive surface 402 can be a capacitive touchpad that can sense the location of an object, such as a finger or stylus, on the surface of the touchpad based on capacitive coupling between capacitors in the touchpad and the object. In another embodiment, the touch-sensitive surface can be a resistive touchpad that is pressure-sensitive, and can detect the pressure of an object against the touchpad, where the pressure causes conductive layers, traces, switches, etc. in the touchpad to electrically connect.

In an embodiment, the unlock code is a pre-determined finger movement 404, such as the “Z” pattern shown in FIG. 4. The finger movement 404 can be user-defined, or pre-determined. Upon the sensing of a correct unlock code, the PLED 100 becomes activate as described earlier. The finger movement 404 can be any type of motion, such as a horizontal, vertical or diagonal slide or swipe. Alternatively, the finger movement 404 can be a series of touches to the touchpad, such as applying pressure to the upper right corner, followed by applying pressure to the lower left corner.

In an embodiment, the touch-sensitive surface 402 can display a keypad, such as the numeric keypad shown in FIG. 3. However, instead of physical keys, the keys are displayed on the touchpad and allows for user selection via a finger, stylus, or any other suitable selection object.

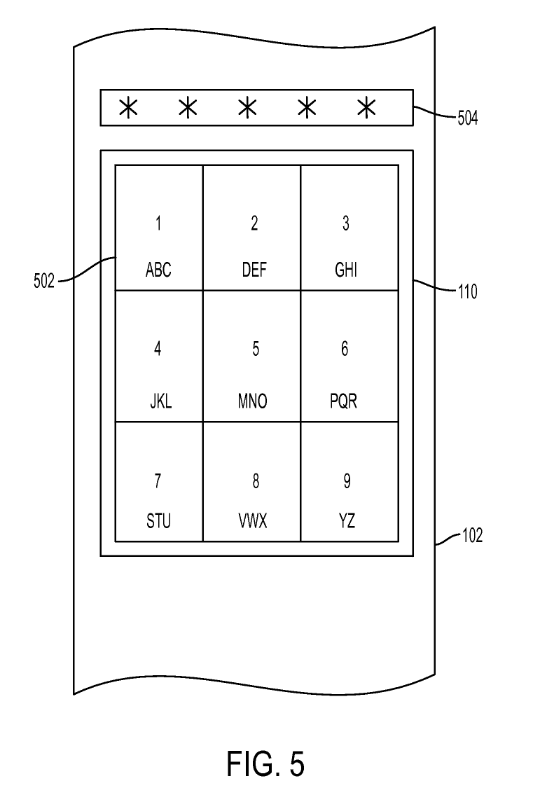

FIG. 5 is a view of a lock interface having an alpha-numeric keypad. In an embodiment, the lock interface 110 consists of an alpha-numeric keypad, allowing input to be based on numbers and letters. The lock interface 110 is located on the housing 102, and can include a plurality of input keys 502. In order to activate the PLED 100, a correct unlock code must be entered using the input keys 502. The unlock code can consist of a string of numbers, a string of letters, or a combination of both. For example, an unlock code could be “JOHN1980”, or “999LOCK”. The unlock code can be a short as one digit, or as long as the user desires.

In an embodiment, the indicator 504 is a liquid-crystal display that can indicate the status of the PLED 100, can display each alpha-numeric digit as it is entered, or any other information regarding the status or operation of the PLED 100.

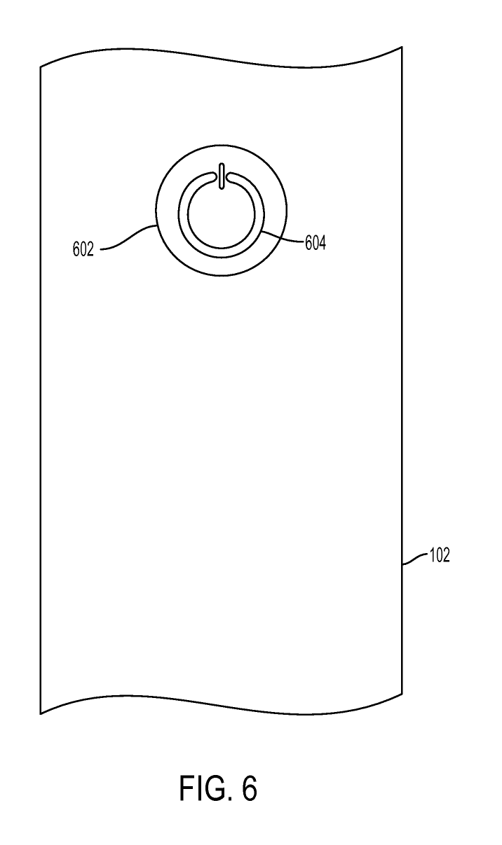

FIG. 6 is a view of a lock interface having a single push-button. The push button 602 allows the user to input a sequence of clicks and/or clicks and holds to unlock or lock the PLED 100. For example, the sequence can be two short presses, followed by two long presses. In an embodiment, a short press is a depression lasting up to two seconds, and a long press is a depression lasting greater than two seconds. The PLED 100 remains inactive until a correct unlock code is entered by the user, thus preventing inadvertent activation or use by unintended users, such as children or elderly persons.

In an embodiment, the push button 602 includes an indicator 604, such as an indicator light or display, which prompts the user that the PLED 100 is in a programming mode, an unlocked mode, or a locked mode. The indicator 604 can be similar to indicator 118 described above. Alternatively, can be shaped in an International Electrotechnical Commission (IEC) 60417 standard symbol for power, such as IEC 5009 as shown in FIG. 6.

The indicator 604 can illuminate to indicate a different operating state of the PLED 100. For example, in an inactive state where the user must enter an unlock code, the indicator can be dimly lit, or may only illuminate a specific portion of the display. Likewise, the indicator 604 can have a different light output in an inactive or low-powered active state, versus a full-powered active state.

In another embodiment, indicator 604 can blink or otherwise alert the user if the PLED 100 is running low on power, or alternatively, if power source of the PLED 100 is in a fully charged state.

In another embodiment, to unlock the PLED 100, the push button 602 can be depressed for a pre-determined period of time, such as five seconds. Upon having depressed the push button 602 for the requisite time period, the display 604 can illuminate, indicating that the PLED 100 is powered and ready for use. In an embodiment, the indicator 604 can blink or flash for every second the push button 602 is depressed, indicating to the user a duration of depression.

The push button 602 can be used to toggle various types of laser outputs. For example, the push button 602 can focus or broaden the laser output from a beam to a flashlight-like unfocused effect, as well as toggle various laser patterns, such as strobe and dazzle effects. The push button 602 can also be used to toggle different colored laser diodes from being activated, in order to produce different colored laser light outputs.

In yet another embodiment, instead of a lock interface 110, the locking and unlocking mechanism can be a rotary dial surrounding, or integrated with, any portion of the PLED 100. The rotary dial can have numbers or letters, or a combination thereof, where the user can dial an unlock code. This embodiment is similar to a combination lock where the user turns a knob to a particular value when inputting a code sequence.

In another embodiment, the lock interface 110 or push button 602 can include biometric identification and verification technology, such as fingerprint, voice, palm print, iris, retina, hand or finger geometry, and/or DNA recognition. The biometric input can be used to lock or unlock the PLED 100.

The lock interface 110 or push button 602 can be located on any portion of the PLED 100, such as the housing 102, head portion 104, or end-cap.

In another embodiment, the lock interface 110 can include a screw-type switch, where a portion of the switch must be rotated or manipulated to a certain degree in order for a push-down portion of the switch to become enabled.

In another embodiment, a first input means is used to enable the PLED 100 to receive an unlock code, i.e., provided limited access and power to the PLED 100 where the laser diode is not active, and the PLED 100 is in a stand-by mode where the laser diode is not capable of emitting a laser output. In the stand-by mode, the microcontroller is enabled to receive an input signal. A second input means is used to receive an input signal, and transmit the input signal to the microcontroller. If the input signal matches the unlock code, the microcontroller then places the PLED 100 in an active mode where the laser diode is capable of emitting a laser output. In an embodiment, the first and second input means can be combined into a single input means, such as a single switch or button.

In yet another embodiment, a photodetector is used to activate and/or deactivate the laser diode. For example, a light- or infrared light-controlled remote switch can be used to transmit an input signal to a photodetector that is coupled to the PLED 100. The input signal can include information such as an unlock code, firmware data (for upgrading the microcontroller and/or laser diode software on the PLED 100), and laser diode output characteristic data.

The unlocking/locking mechanism described above can be applied to any type of electronic device (flashlights, music/video player, mobile phone, PDA, Blackberry, iPhone, laptop computers, etc.), and is not limited to portable laser illumination devices.

While the principles of this invention have been illustrated in relation to the exemplary embodiments shown herein, the principles of this invention are not limited thereto and include any modification, variation or permutation thereof.

What is claimed is:

1. A portable laser-emitting device, comprising:
a housing;
at least one laser diode placed within the housing;
a power supply coupled to the housing;
a microcontroller placed within the housing, the microcontroller storing an unlock code;
a first input means coupled to the housing, the first input means configured to enable the microcontroller to receive an input signal; and
a second input means coupled to the housing, the second input means configured to transmit the input signal to the microcontroller,
wherein the microcontroller is configured to initially activate the laser diode when the input signal is equal to the unlock code.

2. The portable laser-emitting device of claim 1, wherein the second input means is configured to place the laser-emitting device in an active mode where the laser diode is capable of emitting a laser output.

3. The portable laser-emitting device of claim 1, wherein the first input means is configured to place the laser-emitting device in a stand-by mode where the laser diode is not capable of emitting a laser output.

4. The portable laser-emitting device of claim 1, wherein the first input means and the second input means are combined into a single switch.

5. The portable laser-emitting device of claim 4, wherein the single switch is selected from a group consisting of a button, a slide mechanism, a keypad, a switch, a rotary dial, a screw-type switch, and a touch-sensitive interface.

6. The portable laser-emitting device of claim 1, wherein the microcontroller is configured to store a plurality of unlock codes, wherein each unlock code is associated with a different output characteristic of the laser diode.

7. The portable laser-emitting device of claim 1, wherein the unlock code is unalterable.

8. The portable laser-emitting device of claim 1, wherein the unlock code is alterable.

9. A method of activating a laser-emitting device, comprising the steps of:
receiving an input signal at an input means;
transmitting the input signal from the input means to a microcontroller;
comparing the input signal to an unlock code at the microcontroller; and
enabling the laser-emitting device for use when the input signal equals the unlock code.

10. The method of claim 9, wherein the input means is a photodetector configured to receive a light transmission.

11. The method of claim 9, wherein the input means is a wireless receiver.

12. The method of claim 9, wherein the step of enabling the laser-emitting device consists of coupling the laser-emitting diode to a power supply.

13. The method of claim 9, wherein the step of enabling the laser-emitting device consists of activating the laser diode.

14. The method of claim 9, further comprising the step of determining, at the microcontroller, an output characteristic of the laser diode.

15. The method of claim 14, further comprising the step of emitting a laser from the laser diode based on the output characteristic.

16. A portable light-emitting device, comprising:
a housing;
a laser diode placed within the housing;
a microcontroller coupled to the laser diode; and
an input means coupled to the microcontroller, the input means configured to transmit an input signal to the microcontroller,
wherein the microcontroller is configured to activate or deactivate the light-emitting device based on the input signal.

17. The portable light-emitting device of claim 16, wherein the input means is selected from a group consisting of a button, a slide mechanism, a keypad, a switch, a rotary dial, a screw-type switch, and a touch-sensitive interface.

18. The portable light-emitting device of claim 16, wherein the input means is selected from a group consisting of a RFID transceiver, a Bluetooth transceiver, and a Zigbee transceiver.

19. The portable light-emitting device of claim 16, wherein the microcontroller is configured to control an output intensity of the laser diode based on the input signal.

20. The portable light-emitting device of claim 16, wherein the microcontroller is configured to control a flicker rate of the laser diode based on the input signal.
